(19) United States
(12) Patent Application Publication
(10) Pub. No.: US 2023/0365045 A1
(43) Pub. Date: Nov. 16, 2023

(54) Rolling Truck Bed Tray

(71) Applicant: Hung Nguyen, Spring, TX (US)

(72) Inventor: Hung Nguyen, Spring, TX (US)

(21) Appl. No.: 18/223,704

(22) Filed: Jul. 19, 2023

Related U.S. Application Data
(63) Continuation-in-part of application No. 17/234,734, filed on Apr. 19, 2021.

(51) Int. Cl. B60P 1/00

(52) U.S. Cl. CPC B60P 1/003

(57) ABSTRACT

An article of manufacture for providing a foldable rolling truck bed tray with a folding end is disclosed. The article includes a main tray component with a width that fits within the bed of a pickup truck, a folding extension component coupled to the main tray component by one or more hinges, and a plurality of casters coupled to an underside of the main tray component and the underside of the folding extension component. The folding extension component has an open position in which the main tray component and folding extension component are oriented at a common height above the bed of the pickup truck and a closed position in which the folding extension component is oriented on top of the main tray component.

### CROSS-REFERENCE TO RELATED APPLICATION

This application claims priority to U.S. Pat. Application No. 17/234,734, titled “Rolling Truck Bed Tray,” and filed on Apr. 19, 2021. The entire application is incorporated herein by reference in its entirety.

### TECHNICAL FIELD

This application relates in general to an article of manufacture for providing a pickup truck accessory, and more specifically, to an article of manufacture for providing a foldable rolling truck bed tray.

### BACKGROUND

Individuals in large numbers own and use pickup trucks to move material and items of all sizes, shapes, and weights from one place to another. Loading these items into a bed of a pickup truck typically has these individuals reaching over an extended tailgate that has been folded down to provide access to the internal space of the truck bed. Items are lifted up onto the tailgate and then positioned further within the truck bed. This multiple step process may include climbing up onto the truck bed or tailgate to move items farther into the bed. All of these steps are inefficient and require a significant amount of effort.

Many items placed on a truck bed also tend to roll around during transport. This creates spillage, breakage, and generally an unsafe condition for cargo and vehicle while in motion.

Therefore, a need exists for an article of manufacture for providing a foldable rolling truck bed tray with a folding end for extending over a tailgate. The present invention attempts to address the limitations and deficiencies in prior solutions according to the principles and example embodiments disclosed herein.

### SUMMARY

In accordance with the present invention, the above and other problems are solved by providing an article of manufacture for a foldable rolling truck bed tray with a folding end for extending over a tailgate according to the principles and example embodiments disclosed herein.

In one embodiment, the present invention is an article of manufacture for providing a foldable rolling truck bed tray with a folding end for extending over a tailgate. The article includes a main tray component having a width that fits within a bed of a pickup truck, a folding extension component coupled to the main tray component by one or more hinges, and a plurality of casters coupled to an underside of the main tray component and the underside of the folding extension component, and a plurality of attachment devices coupled to a wall and a floor surface of a truck bed for securing the foldable rolling truck bed tray in place. The folding extension component has an open position in which the main tray component and folding extension component are oriented at a common height above the bed of the pickup truck and a closed position in which the folding extension component is oriented on top of the main tray component.

In another aspect of the present invention, a combined length of the main tray component and the folding extension component in the open orientation is less than the length of the bed of the pickup truck with its tailgate in a closed orientation.

In another aspect of the present invention, a plurality of casters are coupled to an underside of the main tray component and multiple casters are coupled to the underside of the folding extension component.

In another aspect of the present invention, the folding extension component comprises a folding tray front edge, a pair of folding tray side, a folding tray outer edge having a coupling slot, and a plurality of top edge stops along an outer edge to restrain items from moving on the foldable rolling truck bed tray when in the open orientation.

In another aspect of the present invention, the main tray component and the folding extension component are made of one or more of the following materials: aluminum, steel, wood, and synthetic materials.

In another aspect of the present invention, the attachment devices comprise an attachment bracket, a movable plate, a restraining wedge, and a rear wedge, the attachment bracket having a top member, a side member, and a bottom member.

In another aspect of the present invention, the foldable rolling truck bed tray further comprises a retention system for securely holding the foldable rolling truck bed tray in place using the plurality attachment devices.

In another aspect of the present invention, the retention system can also be integrated into one bar comprising of the attachment bracket, the front and rear restraining wedge. The bar is designed to be separated so that lengths can be adjusted for different truck bed lengths.

In another aspect of the present invention, the movable plate engages the restraining wedge to secure the foldable rolling truck bed tray in place when in a stowed orientation and engages the rear wedge to secure the foldable rolling truck bed tray in place when in an open orientation.

In another aspect of the present invention, the retention system comprises a release strap coupled to the movable plate for disengaging the movable plate when coupled to the restraining wedge and the rear wedge.

In another aspect of the present invention, the retention system comprises a restraining magnet coupled the main tray component for coupling to the attachment bracket to hold the foldable rolling truck bed tray in place.

In another aspect of the present invention, the restraining magnet comprises an earth magnet to engage the side member of the attachment bracket.

In another aspect of the present invention, the restraining magnet comprises an electro-magnet electrically coupled to a power source by a switch.

In another aspect of the present invention, the power source corresponds to an electrical system of the truck.

In another aspect of the present invention, the bottom member of the attachment bracket is coupled to floor surface of the truck bed and the side member is coupled to the wall of the truck bed.

In another aspect of the present invention, the foldable rolling truck bed tray covers a portion a width of the truck bed.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment of an article of manufacture for providing a foldable rolling truck bed tray with a folding end for extending over a tailgate according to the present invention.

FIG. 2 illustrates a top view of an article of manufacture for providing a foldable rolling truck bed tray with a folding end for extending over a tailgate according to the present invention.

FIGS. 3a-c illustrate various views of an article of manufacture for providing a foldable rolling truck bed tray with a folding end for extending over a tailgate and its components according to the present invention.

FIGS. 4a-b illustrate an embodiment of an article of manufacture for providing a foldable rolling bed tray according to the present invention.

FIGS. 5a-b illustrate views of an embodiment for an article of manufacture for providing a foldable rolling truck bed tray with a folding end for extending over a tailgate according to the present invention.

FIGS. 6a-b illustrate views of installation of restraining brackets within a truck bed used with the article of manufacture for providing a foldable rolling truck bed tray with a folding end for extending over a tailgate according to the present invention.

FIG. 7 illustrates a slot in a main tray component in which a release strap may pass to activate the metal plate as a latch in an embodiment of the article of manufacture for providing a foldable rolling truck bed tray with a folding end for extending over a tailgate according to the present invention.

FIGS. 8a-c illustrate example embodiments of movable plates used in an article of manufacture for providing a foldable rolling truck bed tray with a folding end for extending over a tailgate according to the present invention.

FIG. 9 illustrates an offset movable plate in use within an article of manufacture for providing a foldable rolling truck bed tray with a folding end for extending over a tailgate according to the present invention.

FIGS. 10a-b illustrate a set of views of an attachment device for use with an article of manufacture for providing a foldable rolling truck bed tray with a folding end for extending over a tailgate according to the present invention.

FIGS. 11a-b illustrate a set of views of a restraining wedge for use with an article of manufacture for providing a foldable rolling truck bed tray with a folding end for extending over a tailgate according to the present invention.

FIGS. 12a-b are views of an attachment device for use with an article of manufacture for providing a foldable rolling truck bed tray with a folding end for extending over a tailgate according to the present invention.

FIG. 13 illustrates an example electrical circuit for an electro-magnet attachment device for use with an article of manufacture for providing a foldable rolling truck bed tray with a folding end for extending over a tailgate according to the present invention.

FIGS. 14a-b illustrate another example attachment device for use with an article of manufacture for providing a foldable rolling truck bed tray with a folding end for extending over a tailgate according to the present invention.

FIG. 15 illustrates the integrated bar of the retention bracket, front and rear retention wedges. Bar also shows jigsaw cut to enable inserts to adjust lengths to accommodate different truck bed lengths.

### DETAILED DESCRIPTION

This application relates in general to an article of manufacture for providing a pickup truck bed accessory, and more specifically, to an article of manufacture for providing a foldable rolling truck bed tray with a folding end according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps, or components, but do not preclude the presence or addition of one or more other features, steps, or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “handyman,” and “user” refer to an entity, e.g., a human, using an article of manufacture for providing a foldable rolling truck bed tray with a folding end associated with the invention. The term user herein refers to one or more users.

The terms “invention” or “present invention” refer to the invention being applied for via the patent application with the title “Rolling Truck Bed Tray.” Invention may be used interchangeably with a folding truck bed tray.

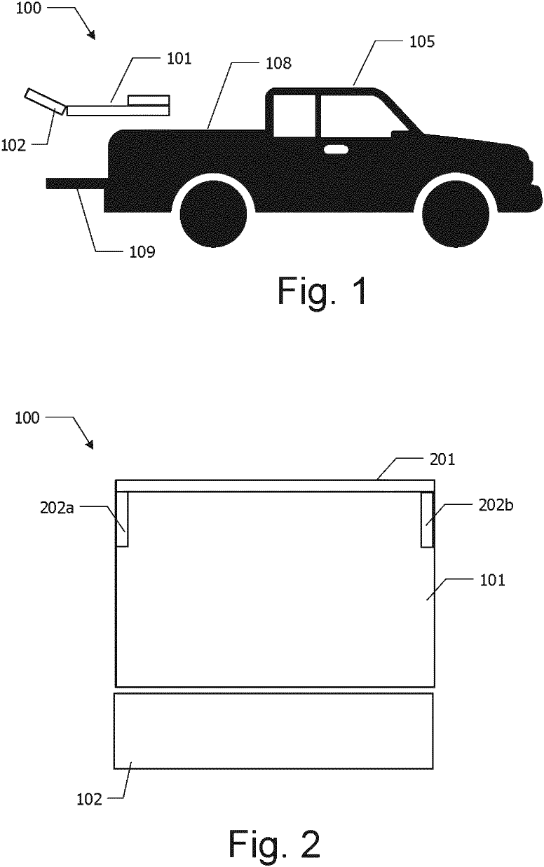

In general, the present disclosure relates to an article of manufacture for providing a pickup truck bed accessory. To better understand the present invention, FIG. 1 illustrates an example embodiment of an article of manufacture for providing a foldable rolling truck bed tray with a folding end for extending over a tailgate according to the present invention. A foldable rolling truck bed tray 100 is shown above a bed 108 of a pickup truck 105 that has its tailgate 109 folded downward. The is made of a main tray component 101 and a folding extension component 102 that is coupled to an outer edge of the main tray component 101.

When in use, the foldable rolling truck bed tray 100 may be positioned toward the tailgate 106 of the pickup truck 105 and the folding extension component 102 folded open to extend to the outer edge of the tailgate 109. Items to be stowed into the pickup truck bed may be placed onto the foldable rolling truck bed tray 100 and once in position, the entire foldable rolling truck bed tray 100 may be rolled back into the pickup truck bed to permit the tailgate 109to be closed.

When the foldable rolling truck bed tray 100 is not in use, the folding extension component 102 may be folded on top of the main tray component 101 to reduce its overall space within the truck bed so that a larger portion of the truck bed is free for use. The bed tray is also designed to be fully removed and stored when the entire truck bed is needed for other purposes.

FIG. 2 illustrates a top view of an article of manufacture for providing a foldable rolling truck bed tray with a folding end for extending over a tailgate according to the present invention. A rear rail 201 and a pair of side rails 202a-b are attached to outer edges of the main tray component 101 on three sides. The folding extension component 102 is shown having a width slightly narrower than the width of the main tray component 101 to permit the folding extension component 102 to be folded over and positioned on top of the main tray component 101 between the pair of side rails 202a-b.

Both the main tray component 101 and the folding extension component 102 possess casters or similar wheels on their respective lower surfaces when unfolded to permit the foldable rolling truck bed tray 100 to roll up and down the length of the pickup truck bed. The foldable rolling truck bed tray 100 may be made of wood, steel, aluminum, or synthetic materials having a thickness sufficient to support a desired weight of a load of items to be placed onto the foldable rolling truck bed tray 100. In one embodiment, a wooden foldable rolling truck bed tray 100 is made from 0.75“ or thicker wood. For a similar foldable rolling truck bed tray 100 made from aluminum, the foldable rolling truck bed tray 100 is made from 0.125 or thicker aluminum.

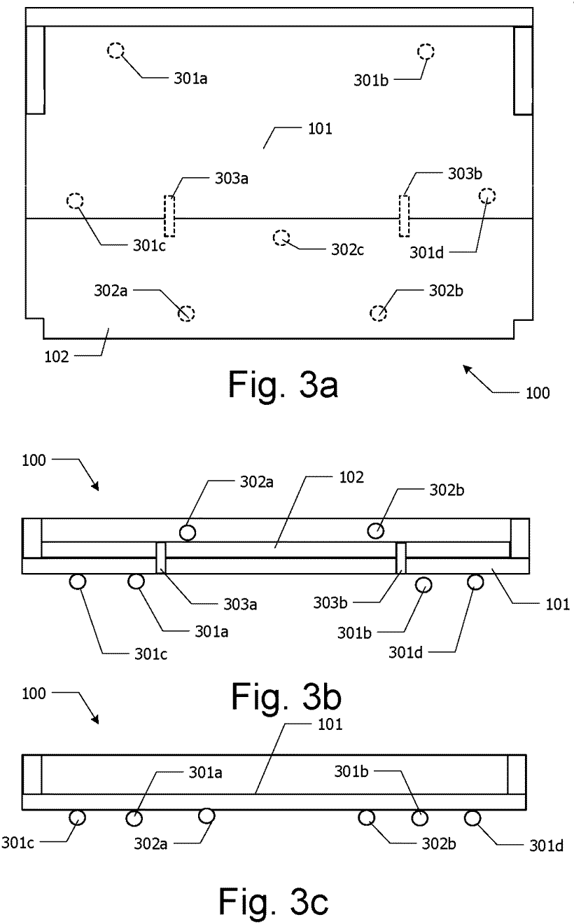

FIGS. 3a-c illustrate various views of an article of manufacture for providing a foldable rolling truck bed tray with a folding end for extending over a tailgate and its components according to the present invention. FIG. 3a shows a top view of a foldable rolling truck bed tray 100 in which the folding extension component 102 is extended in an open position from the main tray component 101. In this embodiment, the pair of side rails 202a-b run only a partial way down the sides of the main tray component 101. As such, the folding extension component 102 may be the same width at the joint where the main tray component 101 and the folding extension component 102 meet. The outermost edge of the folding extension component 102 may need to be narrowed along its outer edge so that the folding extension component 102 may fold over onto the main tray component 101 and permit a portion of the folding extension component 102 to rest between the pair of side rails 202a-b. The longer the pair of side rails 202a-b are made, the more of the folding extension component 102 must be narrowed.

Locations for a set of casters 301a-d are shown under the main tray component 101 and locations of a pair of casters 302a-b are shown under the folding extension component 102. The number of casters 301 a-d will vary depending on load capacity of the tray. Locations of a pair of hinges 303a-b also are shown connecting the main tray component 101 to the folding extension component 102. The number of hinges 301a-b needed may be determined by the strength of the hinges, the weight of the folding extension component 102 to be folded over onto the main tray component 101, and possibly the weight of a load of items expected to be placed onto the foldable rolling truck bed tray 100.

FIG. 3b shows a front view of the foldable rolling truck bed tray 100 having the folding extension component 102 in its closed position. The casters 302a-b from the underside of the folding extension component 102 are shown on top of the foldable rolling truck bed tray 100. The hinges 303a-b are visible connecting the main tray component 101 and the folding extension component 102.

FIG. 3c shows the foldable rolling truck bed tray 100 with the folding extension component 102 in an open position. In this orientation, all of the casters 301a-d and 302a-b are on the underside of the foldable rolling truck bed tray 100. The main tray component 101 and the folding extension component 102 are shown being positioned at the same height above the pickup truck bed to create a single flat surface.

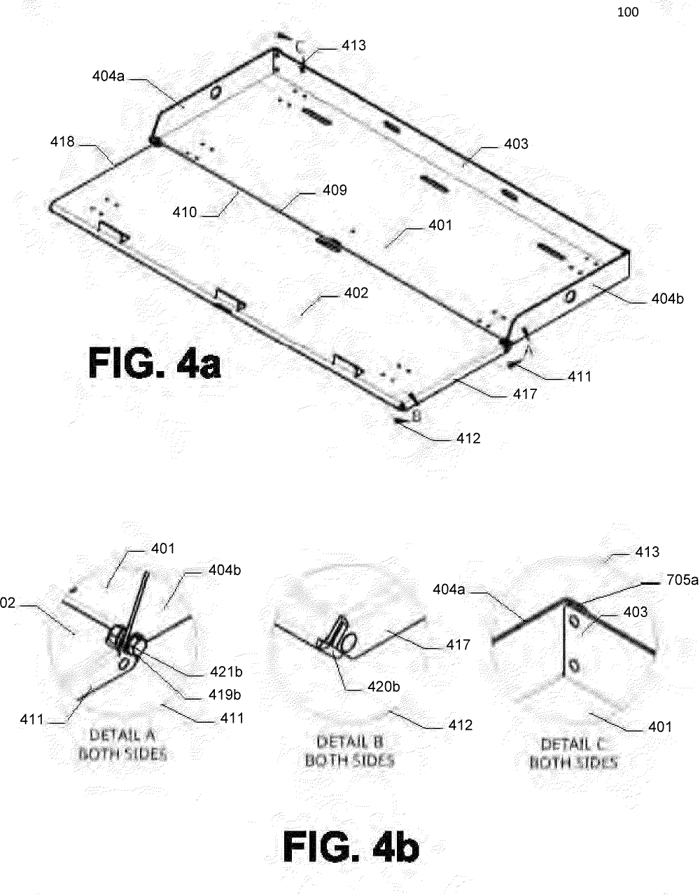

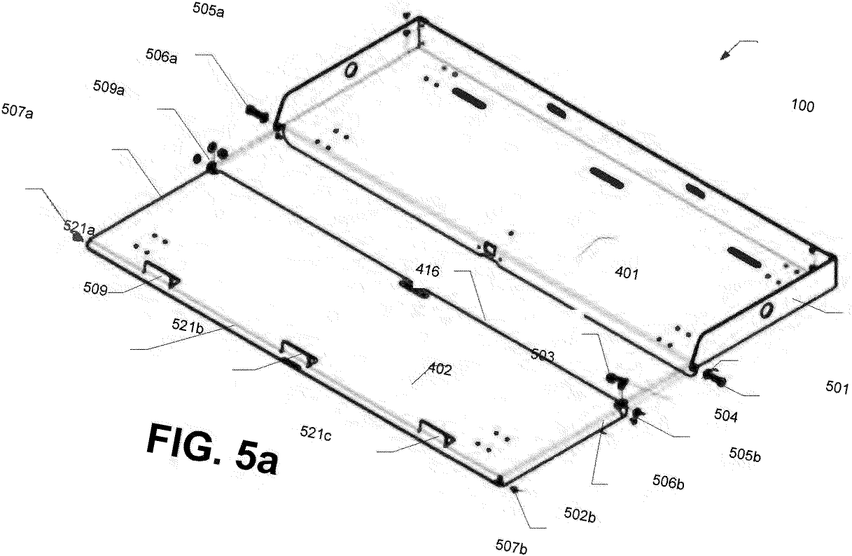

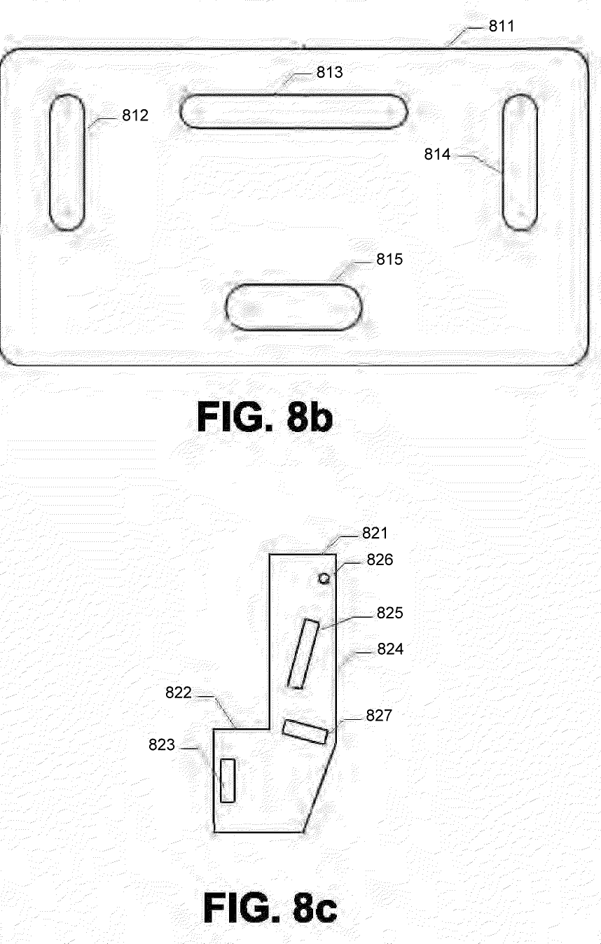

FIGS. 4a-b illustrate an embodiment of an article of manufacture for providing a foldable rolling truck bed tray with a folding end for extending over a tailgate according to the present invention. The embodiment 400 of FIG. 4a includes a main tray component 401 coupled to a folding extension component 402 along inner edges 409-410 of each. The main tray component 401 includes a main tray rear edge component 403 and a pair of main tray side edge components 404a-b coupled to rear and side edges of the main tray component 401. Similarly, the folding extension component 402 also includes edge components 416-418 as disclosed in more detail in reference to FIG. 8a herein.

The folding extension component 402 pivots about a pair of hinge points 421a-b on opposing sides of the main tray component 401 and folding extension component 402 inner edges 409-410. FIG. 4b shows detail views 411-413 of one of the hinge points 411, one corner joint between the front edge component 416 and one of the side edge components 417 along the folding extension component 402, and one corner joint between the rear edge component 403 and one of the side edge components 404a-b along the main tray component 401.

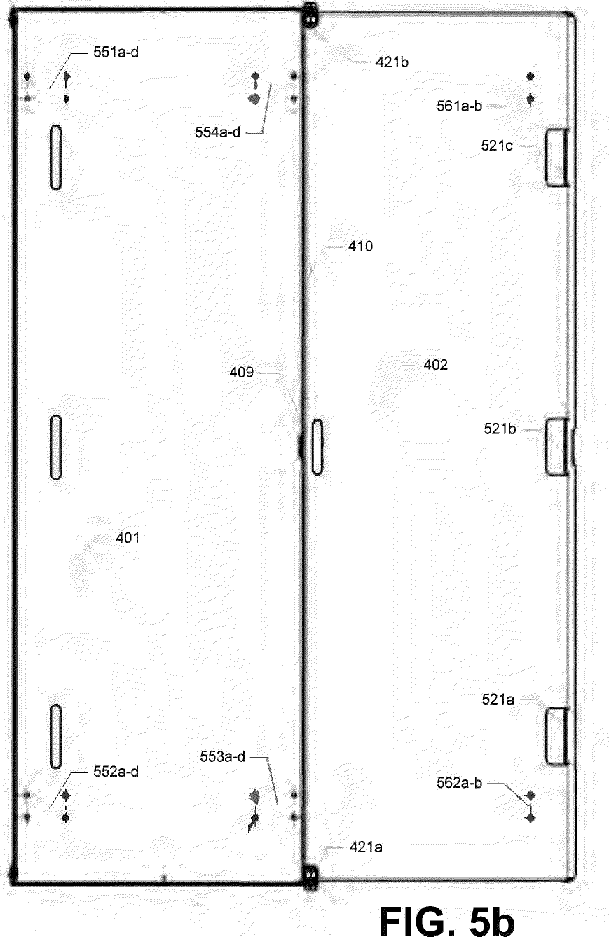

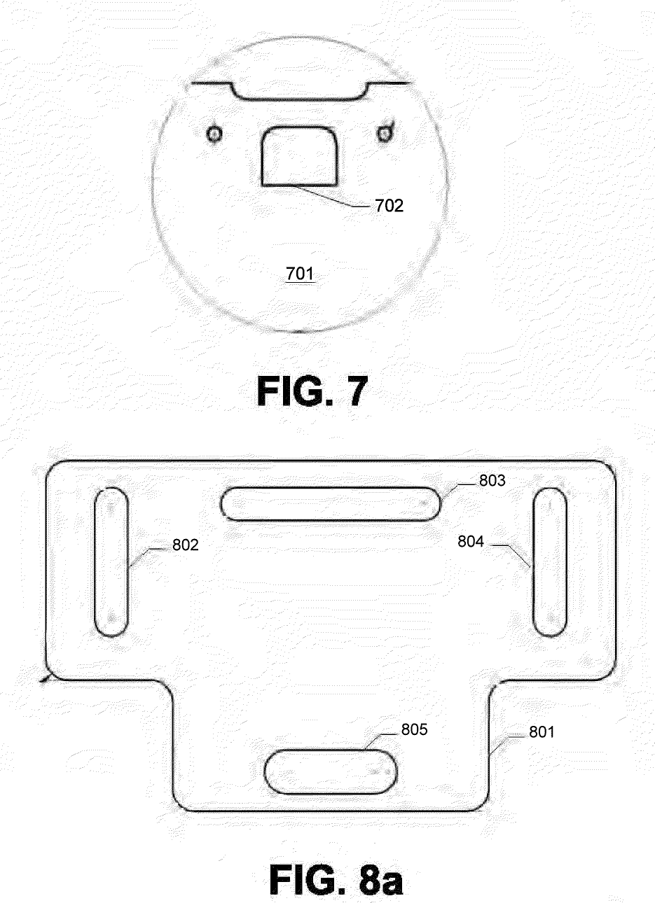

Each of the hinge points 421a-b shown in detail view 411 of FIG. 4b include a hinge pin 505a-b and securing nuts 506a-b to connect the main tray component 401 and folding extension component 402 together as shown in more detail in FIG. 5b. Each corner joint of the folding extension component 402 is similar to each other as shown in detail view 412. An end tab 419b on each opposing end of the front edge component 416, shown in FIG. 5a, of the folding extension component 402 is coupled to a mating tab 420b on each of the side edge components 417-418 of the folding extension component 402. Similarly, a pair of corner joints, one of which is shown in detail view 413, is formed when an end tab 705a, as shown if FIG. 7, of each of the main tray side edge components 404a wraps behind the corresponding end of the main tray rear edge component 403.

FIG. 5a illustrates views of an embodiment of an article of manufacture for providing a foldable rolling truck bed tray with a folding end for extending over a tailgate according to the present invention. The main tray component 401 and folding extension component 402 are shown separated from the hinge points 421a-b. The main tray rear edge component 403 and main tray side edge components 404a-b are shown extending upward from the main tray component 401. Similarly, the edge components 416-418, shown in FIG. 4a, of the folding extension component 402 are shown extending downward from the folding extension component 402 main body.

The hinge pins 505a-b and securing nuts 506a-b are shown about through holes in the main tray side edge components 404a-b of the main tray component 401 and the edge components 417-410 of the folding extension component 402. The hinge pins 505a-b are installed into these through holes to join the main tray component 401 to the folding extension component 402 about the hinge points 421a-b. The folding extension component 402 pivots about the hinge points 421a-b as the folding extension component 402 folds on top of the main tray component 401 in a stowed orientation and extends outward across the truck bed 109 in an open orientation.

FIG. 5b illustrates a top view of an article of manufacture for providing a foldable rolling truck bed tray with a folding end for extending over a tailgate according to the present invention. The main tray component 401 is shown coupled to the folding extension component 402 in the open orientation with the inner edges 409-410 adjacent to each other forming the hinge between the components. The hinge points 421a-b are shown at each end of the inner edges 409-410. As shown in FIGS. 3, a set of casters (not shown) are mounted on the underside of the main tray component 401 and the folding extension component 402 when the foldable rolling truck bed tray 100 is in the open orientation. Attachment holes 551a-d, 552a-d, 553a-d, and 554a-d are shown at various locations across the main tray component 401. Similarly, caster mounting hole sets 561a-b and 562a-b is shown on the folding extension component 402.

The folding extension component 402 has the folding tray inner edge 410, a pair of folding tray side edges 502a-b, and a folding tray outer edge 509. A set of top edge stops 521a-c extend upward from the folding extension component 402 to provide a retention edge for items placed to the top of the folding extension component 402 when in the truck bed 108.

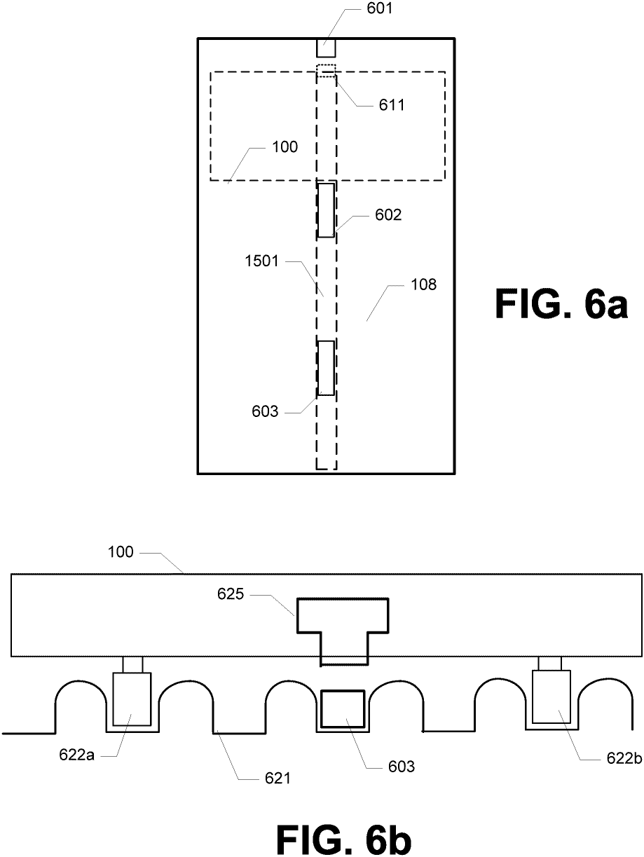

In a preferred embodiment, the main tray component 401 has dimensions of approximately 48.25” × 16” and the folding extension component 402 has dimensions of 48” × 15” The foldable rolling truck bed tray 100 is made of 0.125” thick aluminum. This embodiment is intended for use in a full-size pickup truck, a FORD F-150™ or similar vehicle. One skilled in the art will appreciate that the foldable rolling truck bed tray 100 and its components may be reduced in size to fit within mid-sized and smaller pickup truck beds. FIGS. 6a-b illustrate views of installation of restraining brackets within a truck bed used with the article of manufacture for providing a foldable rolling truck bed tray with a folding end for extending over a tailgate according to the present invention.

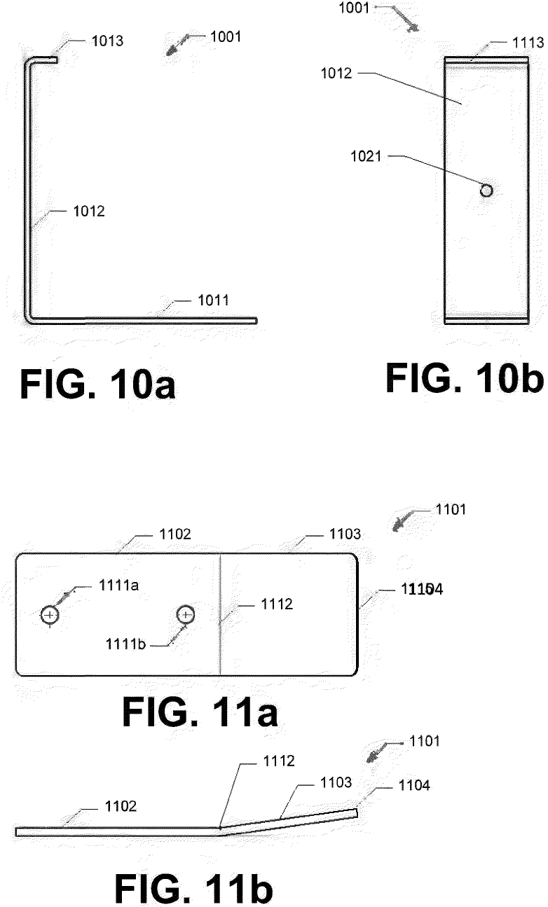

FIG. 6a shows a top view of a truck bed 108 having attachment devices installed for restraining the movement of a foldable rolling truck bed tray 100 therein. A foldable rolling truck bed tray 100 is shown in a stowed orientation in which the foldable rolling truck bed tray 100 is positioned near a front end of the truck bed 108. An attachment device 601, also referred to as a front restraining bracket 1001 as described in detail in reference to FIGS. 10a-b, is coupled to the front wall of the truck bed to engage the foldable rolling truck bed tray 100 when positioned against the front wall of the truck bed 108. A restraining magnet 611 is coupled to the foldable rolling truck bed tray 100 and configured to magnetically engage the restraining bracket 1001 to hold the foldable rolling truck bed tray 100 in place.

The restraining bracket 1001 wraps about the foldable rolling truck bed tray 100 to prevent the foldable rolling truck bed tray 100 from disengaging. A user may move the foldable rolling truck bed tray 100 by pulling on one edge of the foldable rolling truck bed tray 100 and applying sufficient force to overcome the restraining magnet 611 allowing the foldable rolling truck bed tray 100 to move on its caster wheels 622a-b. The foldable rolling truck bed tray 100 may be reattached by rolling truck bed tray 100 on the caster wheels 622a-b toward the front of the truck bed 108 until the restraining magnet 611 reengages the restraining bracket 1001.

When the foldable rolling truck bed tray 100 is positioned with the restraining magnet 611 engaging the restraining bracket 1001, the attachment device 602, also described in detail in reference to FIGS. 11, serves as a restraining wedge 1101 that engages a movable plate 625 to restrain movement of a rear edge of the folding truck bed tray 100. The movable plate 625 is coupled to the rear edge of the foldable rolling truck bed tray 100 and configured to engage a raised front edge of the attachment device 602 when the foldable rolling truck bed tray 100 is in the stowed orientation.

The movable plate 625 is gravity operated to be positioned in a lowered position about the truck bed 108 such that the movable plate 625 is low enough to engage the raised edge of the attachment device 1101. A user may disengage the movable plate 625 from the attachment device 602 by raising the movable plate 625 to an upper position such that the raised edge of the restraining wedge 1101 is no longer in contact with the movable plate 625. The foldable rolling truck bed tray 100 may be moved once the movable plate 625 is in the raised position. When the user releases the movable plate 625, the movable plate 625 returns to the lowered position. In a preferred embodiment, a release strap (not shown) may be coupled to the movable plate 625 and configured to apply a force to a top edge of the movable plate 625 such that it rises from the lowered position on its attachment points.

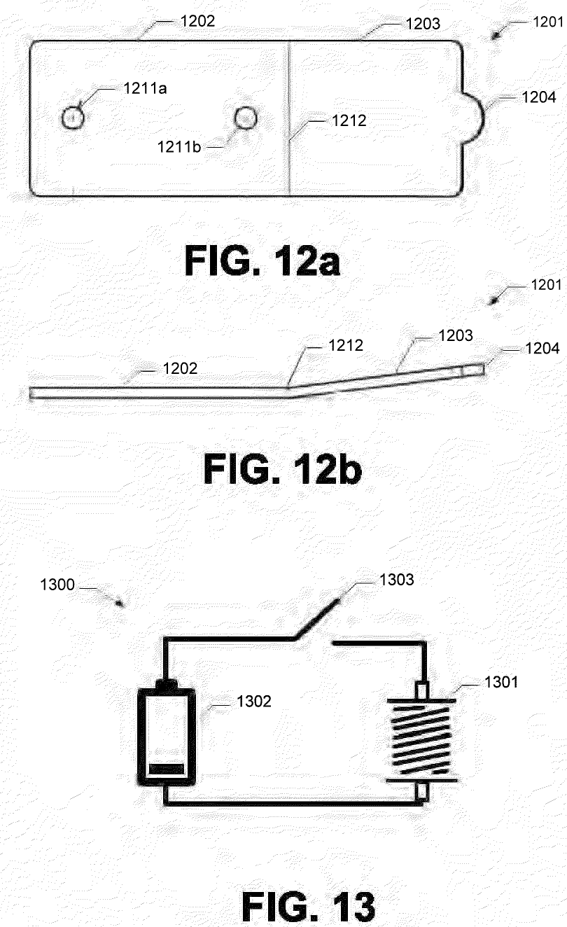

When the foldable rolling truck bed tray 100 is in the open orientation, a rear edge of the foldable rolling truck bed tray 100 extends farther down the truck bed 108. The foldable rolling truck bed tray 100 is held in place using the attachment device 603, which is also described in detail in reference to FIGS. 12 to be a rear wedge 1201. The attachment device 603 engages the movable plate 625 in a similar manner as described above.

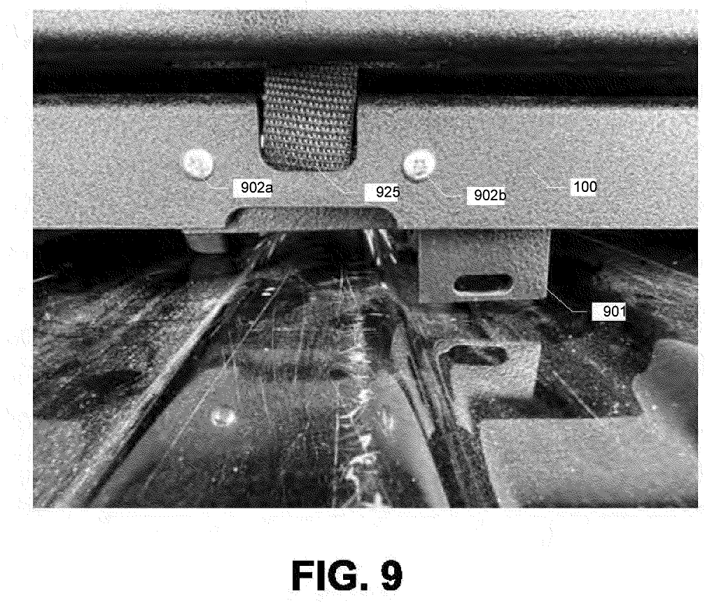

FIG. 6b shows an end view of a truck bed 108 having attachment devices installed for restraining the movement of a foldable rolling truck bed tray 100 therein. A floor surface 621 of the truck bed 108 is shown having a plurality of raised surfaces running lengthwise along the truck bed. The attachment devices 602-603 position the respective wedges between the raised surfaces. The movable plate 625 is T-shaped in this embodiment to permit a bottom edge of the movable plate 625 to fit between a pair of the raised surfaces when it engages the attachment devices 602-603. Embodiments of the foldable rolling truck bed tray 100 installed into truck beds 108 that do not include the raised surfaces, or have different truck bed patterns may utilize a movable plate 1102 that is rectangular in shape as shown in FIGS. 10b, or a pivot type plate as shown in FIG. 9c.

Additionally, the caster wheels 622a-b, which are shown to be a pair of wheels in FIG. 6b, include all of the wheels on the underside of the foldable rolling truck bed tray 100 as described in detail in reference to FIGS. 3a-c above. The caster wheels 622a-b are sized to fit between the raised surfaces in the example embodiment of FIG. 6b permitting the caster wheels 622a-b to be restrained from side-to-side movement by the raised surfaces. Various embodiments of the foldable rolling truck bed tray 100 may utilize different sized caster wheels to match the floor surface 621 of each corresponding pickup truck into which the folding truck bed tray 100 is installed.

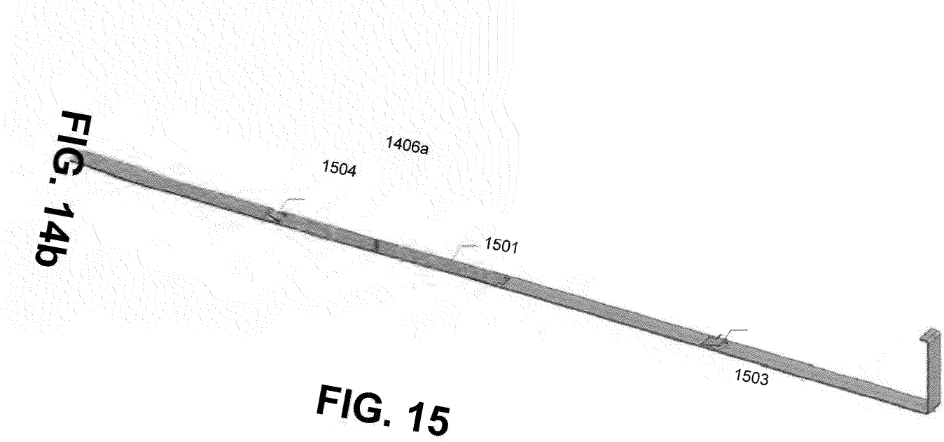

Additionally, the restraining bracket 1001, the attachment device 602 and attachment device 603 can be integrated into a bar 1501 as shown in FIG. 15. This bar is designed in multiple pieces with jigsaw locking cuts and is able to accommodate various truck bed lengths.

Additionally, the foldable rolling truck bed tray 100 is shown sized to be positioned within the truck bed 108 having a width that utilizes most of the available space across the truck bed 108. One skilled in the art will also appreciate that the folding truck bed tray 100 may be sized to use only a portion of the width of the truck bed 108 with its components and attachment devices described herein positioned in corresponding locations to work with the smaller width of the foldable rolling truck bed tray 100. For example, a foldable rolling truck bed tray 100 using half of the width of the truck bed 108 may be positioned in the center of the truck bed 108. The foldable rolling truck bed tray 100 may also be positioned toward either side of the truck bed 108 as desired. In each of these locations, the attachment devices 601-603 may be moved to interact with the foldable rolling truck bed tray 100 in a similar manner as described herein with respect to a full-size folding truck bed tray 100.

FIG. 7 shows a detail view 701 of a through hole 702 in a center position of the front edge component 409. The through hole 702 is used For a release strap to activate the movable plate, shown in FIGS. 9a-c, while simultaneously pull tray towards tailgate.

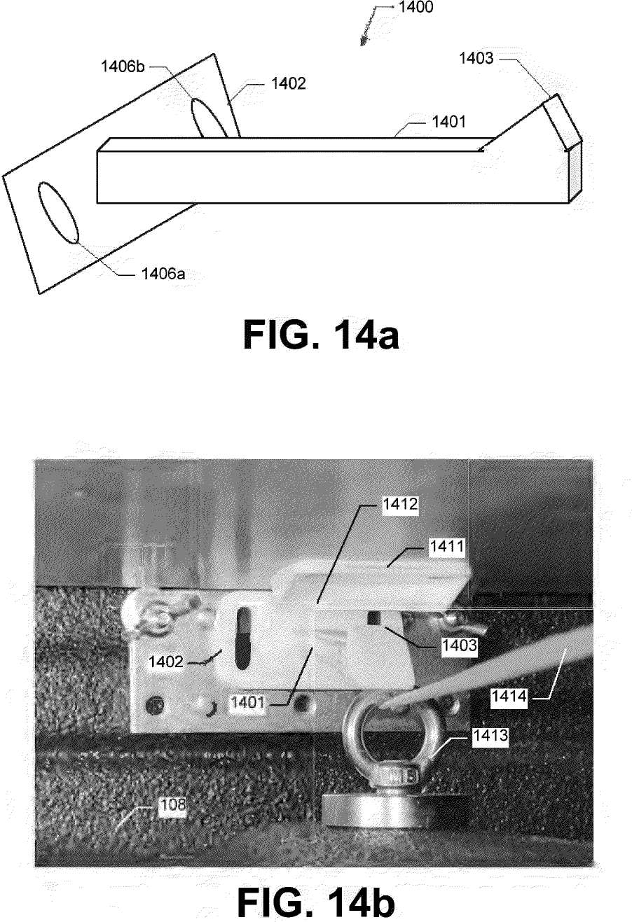

FIGS. 8a-c illustrate example embodiments of movable plates used in an article of manufacture for providing a foldable rolling truck bed tray with a folding end for extending over a tailgate according to the present invention. The movable plate 625 disclosed in reference to FIGS. 6a-b herein, is used to couple the foldable rolling truck bed tray 100 to a truck bed 108 using the restraining wedge 1101 and the rear wedge 1201 shown in detail in FIGS. 11-12, or with the integrated bar shown in FIGS. 14 with built in wedges 1503 and 1504.

FIG. 8a shows a T-shaped restraining plate 801 having a wedge catching slot 805 about a bottom edge, a release strap slot 803 about a top edge, and a pair of attachment post slots 802 and 804 about opposing sides of the movable plate 801. FIG. 8b shows a similar rectangular movable plate 811 having a corresponding a wedge catching slot 815 about a bottom edge, a release strap slot 813 about a top edge, and a pair of attachment post slots 812 and 814 about opposing sides of the movable plate 811.

The wedge catching slot 805, 815, and 824 about a bottom edge engages a front end of the restraining wedge 1101 and the rear wedge 1201 when the foldable rolling truck bed tray 100 is in its corresponding orientation as described above in reference to FIGS. 6a-b. It also engages with the integrated bar in FIG. 15 at front 1503 and rear 1504. The release strap slot 803, 813, and 825 about a top edge permits a release strap 925, shown in FIG. 9, to pull the movable plate 801, 811, and 821 upward from the restraining wedge 1101 and the rear wedge 1201 to move the foldable rolling truck bed tray 100 within the truck bed 108. The same concept also works with integrated bar 1501 and front lock position 1503 and rear lock position 1504. The pair of attachment post slots 802 and 804 about opposing sides of the movable plate 801, a similar pair of attachment post slots 812 and 814 about opposing sides of the movable plate 811 permits the movable plates 801 and 811 to be mounted onto a pair of attachment posts 902a-b on the main tray component 101.

When the user releases the release strap 925, gravity causes the movable plate 801, 811 to fall until the attachment posts move to the upper end of the attachment post slots 802, 804 and 812, 814 to permit the movable plate 801, 811 to engage the coupling slots 805, 815 of the restraining and rear wedges 1101, 1201 described in detail in reference to FIGS. 11-12 below.

FIG. 8c shows an offset moveable plate. The offset movable plate 821 allows the restraining wedge 1101 or the integrated bar to be located a distance from the attachment posts that holds the movable plate 821 to engage the restraining wedge 1101 or the integrated bar not directly below the center of the movable plate as shown in reference to FIG. 9. Offset plate 821 comprises of a horizontal top portion 824, a vertical lower portion 822, and a corresponding a wedge catching slot 823 about a bottom edge, a release strap slot 825 about a top edge, a pivot point 826 and an attachment post slot 827.

In the embodiment of FIG. 8c, the attachment posts pass through hole 826 and slot 827. When a user is pulling upon the release strap 925, the movable plate 821 pivots upward around hole 826 and the attachment posts move to a lower end of the attachment post slot 827. When the user releases the strap 925, gravity causes offset movable plate 821 to all until the attachment post move to the upper end of post slot 827 to engage in the front wedge 602 or rear wedge 603. If the integrated bar is used, the offset removable plate will engage with features 1503 and 1504 on the integrated bar 1501.

As noted in reference to FIG. 6b, the floor surface of the truck bed 108 may present various configurations depending upon a particular model of pickup truck into which the foldable rolling truck bed tray 100 is installed. The possible location of the restraining wedges, or the integrated bar, relative to the center of the folding extension component 102 may differ between different truck models and their respective floor surface configurations. Use of the offset movable plate 821 permits the adjustment of the interaction of the movable plates and the restraining wedges or the integrated bar without changing configuration of other components within the foldable rolling truck bed tray 100. FIG. 9 shows an example embodiment of an offset movable plate 901 extending downward below the folding extension component 102 a short distance from the release strap 925 and the corresponding release strap slot described herein.

FIGS. 10a-b illustrate a set of views of an attachment bracket 1001 for use with an article of manufacture for providing a foldable rolling truck bed tray with a folding end for extending over a tailgate according to the present invention. As disclosed in reference to FIGS. 6a-b, the attachment bracket 1001 is coupled to the front wall and floor surface of the truck bed 108 to engage the restraining magnet 611 coupled to a front end of the main tray component 101. The attachment bracket 1001 includes a horizontal bottom member 1011, a vertical side member 1012, and a horizontal top member 1013.

FIG. 10b shows an attachment hole 1011 for securing 1001 to a front wall of the truck bed 108. FIG. 10c shows an attachment hole 1021 for securing the side member 1012 to the front wall of truck bed 108. Similar attachment holes, not shown, through the bottom member 1011 are used for securing the bottom member 1011 to the bottom surface of the truck bed 108. These attachment holes may accept screws and bolts to couple to the truck bed 108 in an ordinary way. One skilled in art may recognize that other attachment methods including welding, adhesives, and the like may be used in place of the screws or bolts.

The attachment bracket 1001 is sized to permit the main tray 101 to fit between the top member 1013 and the bottom member 1001 in either the open or stowed position with folding component 102 folded onto main tray 101. The foldable rolling truck bed tray 100 may be inserted into the attachment bracket 1001 by a user pushing the foldable rolling truck bed tray 100 on its casters towards the front wall of the truck bed 108. When the foldable rolling truck bed tray 100 is within the attachment bracket 1001, the restraining magnet 611 may engage the side member 1012 to hold the foldable rolling truck bed tray 100 in place.

FIGS. 11 illustrates a set of views of a restraining wedge for use with an article of manufacture for providing a foldable rolling truck bed tray with a folding end for extending over a tailgate according to the present invention. FIG. 11a shows a top view of the restraining wedge 1101 having a flat member 1102 and a rising member 1103 joined at bend 1112. FIG. 11b shows a side view of the restraining wedge. A pair of attachment holes 1111a-b in the flat member 1102 permits the restraining wedge 1101 to be attached to the floor surface of the truck bed 108 in a manner similar to the attachment bracket 1001 described above in reference to FIGS. 10a-b. The upper edge 1104 of the rising member 1103 has a straight edge to engage the wedge catching slot 905 of the movable plate 901, 911 as described in reference to FIGS. 9a-b.

FIGS. 12a-b illustrate views of an attachment device for use with an article of manufacture for providing a truck bed tray with a folding end for extending over a tailgate according to the present invention. FIG. 12a shows a top view of the restraining wedge 1201 having a flat member 1202 and a rising member 1203 joined at bend 1212. FIG. 12b shows a side view of the restraining wedge 1201. A pair of attachment holes 1211a-b in the flat member 1202 permits the restraining wedge 1201 to be attached to the floor surface of the truck bed 108 in a manner similar to the attachment bracket 1001 described above in reference to FIGS. 11a-b. The upper edge 1204 of the rising member 1203 has a half-moon edge to engage the wedge catching slot 905, 915, and 1411 of the movable plate 901, 911 and 1401 as described in reference to FIGS. 9a-c.

FIG. 13 illustrates an example electrical circuit for an electro-magnet attachment device for use with an article of manufacture for providing a foldable rolling truck bed tray with a folding end for extending over a tailgate according to the present invention. As disclosed herein, the foldable rolling truck bed tray 100 may be secured in place within the truck bed 108 using a restraining magnet 611 attached to a front edge of the main tray component 101 that is coupled to a steel attachment bracket 1001 as described in detail in reference to FIGS. 10a-d.

In one embodiment, the restraining magnet 611 may be an earth magnet that possesses sufficient magnetic force to prevent the foldable rolling truck bed tray 100 from moving about the truck bed 108. The magnet couples to the attachment bracket 1001 when the foldable rolling truck bed tray 100 rolls on its caster wheels to cause the restraining magnet 611 to come into contact with the side member 1001 of the attachment device. The side member 1001 is long enough to place the top member 1013 above the foldable rolling truck bed tray 100 while extending over a front edge of the foldable rolling truck bed tray 100. This arrangement places the front edge of the main tray component 101 within the attachment bracket 1001 when the restraining magnet 611 is in contact with the side member 1012.

In an alternate embodiment, the restraining magnet 611 may be replaced with an electro-magnet 1301 shown in a circuit of FIG. 13. The circuit 1300 electrically connects a power source 1302 to the electro-magnet 1301 by an activation switch 1303. When the activation switch 1303 is closed, electrical power is provided to the electro-magnet 1301 to generate an electric field that may be used to couple the foldable rolling truck bed tray 100 to the attachment bracket 1001. When the activation switch 1303 is opened, the electro-magnet 1301 disengages from the attachment bracket 1001 permitting the foldable rolling truck bed tray 100 to be moved on its caster wheels. The activation switch 1303 may replace the functionality of the movable plate 801, 811 and 821 that engages and disengages one of the restraining wedges using the release strap. If the electro-magnet 1301 generates a sufficiently large magnetic field to restrain the movement of the foldable rolling truck bed tray 100, the movable plates engaging the restraining wedges may not be needed. The strength of the magnetic field generated by the electro-magnet 1301 may be adjusted by adjusting output of the power source 1302 to maintain the connection to the attachment bracket 1001.

FIGS. 14a-b illustrate another example attachment device for use with an article of manufacture for providing a foldable rolling truck bed tray with a folding end for extending over a tailgate according to the present invention. In an alternate embodiment, the foldable rolling truck bed tray 100 may be secured in place within the truck bed 108 by mechanically restraining the movement of the foldable rolling truck bed tray 100. In this alternate embodiment, a restraining arm 1400, shown in FIG. 14a, is releasably mechanically coupled to the main tray component 101. The restraining arm 1400 may be coupled to the front wall of the truck bed 108 in place of the attachment bracket 1001 and the restraining magnet 611.

The restraining arm 1400 includes a main arm member 1401 coupled to a mounting plate 1402 at one end and a coupling hook 1403 at an opposing end. The restraining arm 1400 may be coupled to the truck bed 108 mechanically using screws or bolts (not shown) that pass through mounting slots 1404a-b. Other mounting mechanisms may also be utilized.

The main arm member 1401 is semi-flexible in that it may bend upwards and downwards a short distance upon application of a deflection force. The upward and downward motion of the main arm member 1401 causes the coupling hook 1403 to rise and fall a corresponding distance permitting the coupling hook 1403 to engage and disengage the main tray component 101 to permit it to move when desired.

FIG. 14b shows the restraining arm 1400 installed within a truck bed 108 showing the main arm member 1401 pulled downward to disengage the coupling hook 1403 from a retention device 1411 attached to the underside of the main tray component 101. The retention device 1411 includes an engagement surface 1412 to present a vertical surface to engage the coupling hook 1403 when the restraining arm 1400 is coupled in place. The retention device 1411 provides restraining forces against the coupling hook 1403 to prevent the main tray component 101 from moving. The retention device 1411 shown in FIG. 14b utilizes a separate component that is coupled to the 101. The retention device 1411 may also utilize a slot cut into the main tray component 101 that is sized to engage the coupling hook 1403.

In the embodiment of FIG. 14b, the deflection force that bends the main arm member 1401 to move the coupling hook 1403 is applied using a release line 1414 attached to the main arm member 1401 and arranged to be positioned towards the open end of the truck bed 108 permitting a user to pull on the release line 1414 when the restraining arm 1400 is to be disengaged from the main tray component 101. A release line guide 1413 may be coupled to the floor surface of the truck bed 108 about the coupling hook 1403 at the opposing end of the main arm member 1401. The release line 1414 is routed from the main arm member 1401 through the release line guide 1413 as it is run along the truck bed 108. The user pulling upon the release line 1414 applies a downward force upon the main arm member 1401 along the release line 1414 between the main arm member 1401 and the release line guide 1413. When the user stops pulling upon the release line 1414, the main arm member 1401 returns to a rigid position in which the coupling hook 1403 is at an upper position that may engage the retention device 1411. The main arm member 1401 returns to its normal state when the bending caused by the application of the downward force from the release line 1414 is removed.

FIG. 15 shows an integrated bar system to combine components of FIGS. 10, FIGS. 11 and FIGS. 12 into one component. The features and functionality of these components will be similar with the integrated bar. The bar is connected with an interlocking jigsaw cut to allow inserts to be added to accommodate various truck bed lengths.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture for providing a foldable rolling truck bed tray having a folding extension component, the foldable rolling truck bed tray comprises:
a main tray component having a width that fits within a bed of a pickup truck;
the folding extension component coupled to the main tray component by one or more hinges, the folding extension component having an open position in which the main tray component and folding extension component are oriented at a common height above the bed of the pickup truck and a closed position in which the folding extension component is oriented on top of the main tray component; and
a plurality of attachment devices coupled to a wall and a floor surface of a truck bed for securing the foldable rolling truck bed tray in place.

2. The foldable rolling truck bed tray according to claim 1, wherein a combined length of the main tray component and the folding extension component in the open orientation is less than the length of the bed of the pickup truck with its tailgate in a closed orientation.

3. The foldable rolling truck bed tray according to claim 1, wherein a plurality of casters are coupled to an underside of the main tray component and multiple casters are coupled to the underside of the folding extension component.

4. The foldable rolling truck bed tray according to claim 1, wherein the folding extension component comprises a folding tray front edge, a pair of folding tray side, a folding tray outer edge having a coupling slot, and a plurality of top edge stops along an outer edge to restrain items from moving on the foldable rolling truck bed tray when in the open orientation.

5. The foldable rolling truck bed tray according to claim 1, wherein the main tray component and the folding extension component are made of one or more of the following materials: aluminum, steel, wood, and synthetic materials.

6. The foldable rolling truck bed tray according to claim 1, wherein the attachment devices comprise an attachment bracket, a movable plate, a restraining wedge, and a rear wedge, the attachment bracket having a top member, a side member, and a bottom member.

7. The foldable rolling truck bed tray according to claim 6, These devices can also be combined into an integrated bar system with a jigsaw cut-out in order to accommodate inserts to fit various truck bed lengths.

8. The foldable rolling truck bed tray according to claim 6, wherein the foldable rolling truck bed tray further comprises a retention system for securely holding the foldable rolling truck bed tray in place using the plurality attachment devices.

9. The foldable rolling truck bed tray according to claim 8, wherein the movable plate engages the restraining wedge to secure the foldable rolling truck bed tray in place when in a stowed orientation and engages the rear wedge to secure the foldable rolling truck bed tray in place when in an open orientation. These wedges can also be incorporated into an integrated bar system with a jigsaw cut-out in order to accommodate inserts to fit various truck bed lengths.

10. The foldable rolling truck bed tray according to claim 9, wherein the retention system comprises a release strap coupled to the movable plate for disengaging the movable plate when coupled to the restraining wedge, the rear wedge, or the integrated bar system.

11. The foldable rolling truck bed tray according to claim 8, wherein the retention system comprises a restraining magnet coupled the main tray component for coupling to the attachment bracket or the integrated bar system to hold the foldable rolling truck bed tray in place.

12. The foldable rolling truck bed tray according to claim 11, wherein the restraining magnet comprises an earth magnet to engage the side member of the attachment bracket.

13. The foldable rolling truck bed tray according to claim 11, wherein the restraining magnet comprises an electro-magnet electrically coupled to a power source by a switch.

14. The foldable rolling truck bed tray according to claim 13, wherein the power source corresponds to an electrical system of the truck.

15. The foldable rolling truck bed tray according to claim 11, wherein the bottom member of the attachment bracket is coupled to floor surface of the truck bed and the side member is coupled to the wall of the truck bed.

16. The foldable rolling truck bed tray according to claim 11, wherein the foldable rolling truck bed tray covers a portion a width of the truck bed.
